(19) United States
(12) Patent Application Publication
(10) Pub. No.: US 2026/0020120 A1
(43) Pub. Date: Jan. 15, 2026

(54) PORTABLE AREA LIGHT

(71) Applicant: MILWAUKEE ELECTRIC TOOL CORPORATION, Brookfield, WI (US)

(72) Inventors: Jeffrey L. Spenner, Germantown, WI (US); Jonathan J. Kuta, Milwaukee, WI (US); Sriraksha Manjunatha, Wauwatosa, WI (US); Peter G. Diamond, West Allis, WI (US); Ryan A. Spiering, Milwaukee, WI (US); Christina Y. Prestidge-Kadrlik, Pewaukee, WI (US)

(21) Appl. No.: 19/241,900

(22) Filed: Jun. 18, 2025

Related U.S. Application Data
(60) Provisional application No. 63/670,160, filed on Jul. 12, 2024.
(60) Provisional application No. 63/788,241, filed on Apr. 14, 2025.

(51) Int. Cl. H05B 45/10; F21S 9/02; F21Y 115/10

(52) U.S. Cl. CPC H05B 45/10; F21S 9/02; F21Y 2115/10

(57) ABSTRACT

An area light including a base including a battery receptacle for receiving a battery, a LED circuit, an indicator, and a controller coupled to the battery compartment, the LED circuit, and the indicator. The controller is configured to control the LED circuit to output a first lumen level, control the indicator to output a first indication when an instant time remaining of the battery is less than a first predetermined amount of time, control, after the first indication, the LED circuit to output the first lumen level, control the indicator to output a second indication when the instant time remaining of the battery is less than a second predetermined amount of time, the second predetermined amount of time being less than the first predetermined amount of time, and control, after the second indication, the LED circuit to output a second lumen level that is less than the first lumen level.

### CROSS-REFERENCE TO RELATED APPLICATIONS

This application claims priority to U.S. Provisional Patent Application No. 63/670,160, filed Jul. 12, 2024, and U.S. Provisional Patent Application No. 63/788,241, filed Apr. 14, 2025, the entire contents of both of which are incorporated herein by reference.

### FIELD

The present invention relates to area lights, and more specifically, to portable area lights.

### BACKGROUND

Mobile light systems, including area lights, are used to illuminate worksites or other areas without permanent lighting fixtures, outdoor spaces, and/or spaces without electricity. These worksites are often at remote locations, requiring the area lights to be transported to the worksite. Similarly, the worksites may be in locations where vehicles cannot easily maneuver, requiring the area light to be carried to the worksite by an operator. Many portable lights, such as handheld flashlights or small lantern style lights, are easy to carry to the worksites, but do not provide enough light to illuminate the area well enough to provide suitable working conditions. Other larger lights provide sufficient lighting to the worksite but may be cumbersome to transport.

### SUMMARY

Battery-powered tower lights are convenient and effective by providing sufficient lighting for a worksite. However, battery packs have a finite power supply which may be difficult for a user on a worksite to discern. Accordingly, there is a need to adjust a lumen output level of the light based on a remaining battery supply and to alert the user that the battery is nearing depletion. The user is alerted to that the battery has reached certain thresholds based on output from an indicator.

In one embodiment, the invention provides an area light including a base including a battery receptacle for receiving a battery, a LED circuit, an indicator, and a controller coupled to the battery compartment, the LED circuit, and the indicator. The controller is configured to control the LED circuit to output a first lumen level, control the indicator to output a first indication when an instant time remaining of the battery is less than a first predetermined amount of time, control, after the first indication, the LED circuit to output the first lumen level, control the indicator to output a second indication when the instant time remaining of the battery is less than a second predetermined amount of time, the second predetermined amount of time being less than the first predetermined amount of time, and control, after the second indication, the LED circuit to output a second lumen level that is less than the first lumen level.

In a further embodiment, the invention provides a method of controlling an area light. The area light includes including a base having a battery receptacle for receiving a battery, a LED circuit, an indicator, and a controller. The method includes controlling, with the controller of the area light, the LED circuit to output a first lumen level, controlling, with the controller of the area light, the indicator to output a first indication when an instant time remaining of the battery is less than a first predetermined amount of time, and controlling, with the controller of the area light and after the first indication, the LED circuit to output the first lumen level. The method further includes controlling, with the controller of the area light, the indicator to output a second indication when the instant time remaining of the battery is less than a second predetermined amount of time, the second predetermined amount of time being less than the first predetermined amount of time, and controlling, with the controller of the area light and after the second indication, the LED circuit to output a second lumen level that is less than the first lumen level.

In an even further embodiment, the invention provides an area light including a base including a battery compartment for receiving a battery, a LED circuit, and a controller coupled to the battery compartment and the LED circuit. The controller is configured to control the LED circuit to output a first lumen level, control the LED circuit to output a first indication when an instant time remaining of the battery is less than a first predetermined amount of time, control, after the first indication, the LED circuit to output the first lumen level, control the LED circuit to output a second indication when the instant time remaining of the battery is less than a second predetermined amount of time, the second predetermined amount of time being less than the first predetermined amount of time, and control, after the second indication, the LED circuit to output a second lumen level that is less than the first lumen level.

Other aspects of the invention will become apparent by consideration of the detailed description and accompanying drawings.

### BRIEF DESCRIPTION OF THE DRAWINGS

FIG. 1 is a perspective view of a portable area light in a storage configuration.

FIG. 2 is a perspective view of the light of FIG. 1 in an open configuration with a mast partially extended.

FIG. 3 is a block diagram illustrating a controller of the light of FIG. 1, according to some embodiments.

FIG. 4 is a flowchart of a method for controlling an indicator of the light of FIG. 1, according to some embodiments.

FIG. 5 is an eco mode time diagram, according to some embodiments.

FIG. 6 is a low battery alert time diagram, according to some embodiments.

FIG. 7 is a low battery indicator time diagram, according to some embodiments.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

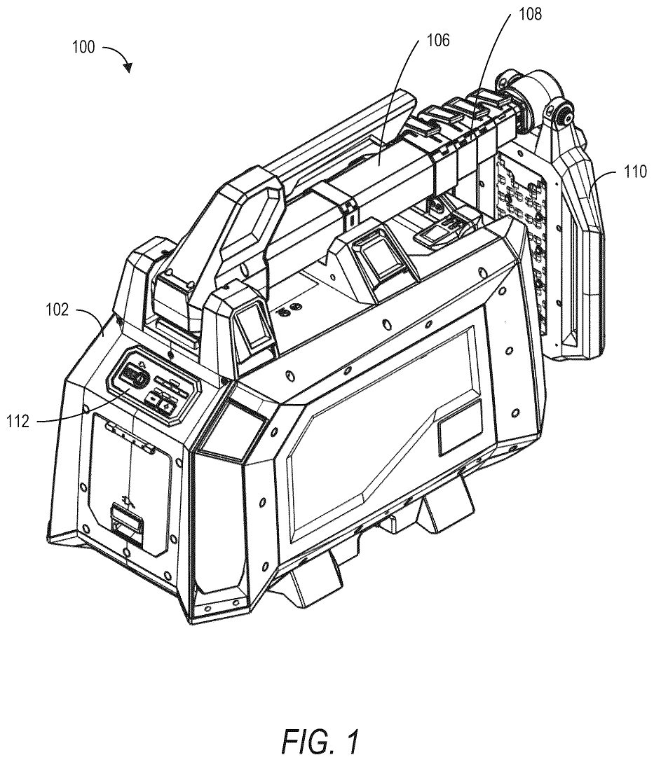

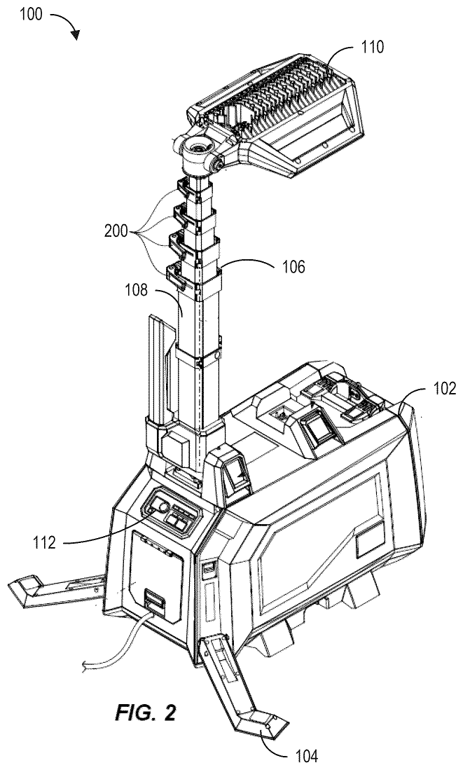

FIGS. 1 and 2 illustrate a portable area light 100 (also referred to herein as an area light, a work light, or simply a light 100) including a base 102, a pair of legs 104, and a light body 106 having a mast 108 and a light head 110. The area light 100 illustrated in the figures and described below is just one example of an area light for use with the invention. In other embodiments, the area light 100 may have other configurations and/or components. For example, the area light 100 may be a tripod-style light, a fixed-body light, a flashlight, a headlamp, or the like. The legs 104 and the light body 106 of the illustrated embodiment are all rotatably connected to the base 102. The work light 100 may be converted between a stowed configuration (FIG. 1) and one or more open or expanded configurations (FIG. 2). When in the open configuration, the light head 110 is supported above a ground or a surface to provide light to the area. When in the stowed configuration, the work light 100 is compact and transportable (e.g., carriable) through a worksite.

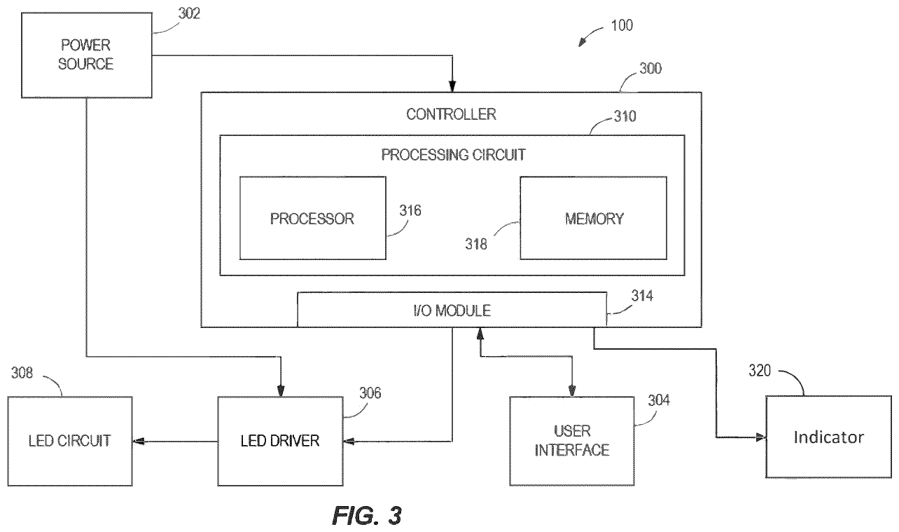

Additionally, the base 102 houses electrical components and other components of the work light 100. A controller 300 (FIG. 3) is disposed within the base 102. A user interface 112 is positioned on the outside of the base 102 and is in communication with the controller 300 to control the operation of the work light 100. The user interface 112 may include any number of controls (real or virtual) including but not limited to a power button, a brightness control, a charge indicator, a mode adjustment button, a power saving mode button, or various other controls. The user interface 112 may further include a display for displaying one or more parameters of the work light 100. For example, the user interface may include an indicator 320 (FIG. 3). In other examples, the display may be a touch screen display allowing for user inputs to be provided via the display. In the illustrated embodiment, the user interface 112 is accessible to an operator both when the work light 100 is in the open configurations and in a stowed configuration.

The work light 100 may optionally be powered by a DC power source 302 (FIG. 3) (for example, one or more batteries) or may be connected to an external power supply (e.g., an AC power source). The base 102 includes a battery compartment for receiving the DC power source 302. The battery compartment includes a battery receptacle having electrical connections for engaging with the DC power source 302.

The legs 104 are rotatably connected to the base 102 and are rotatable between the stowed configuration where the legs 104 are positioned along sides of the base 102 and the open configuration where distal ends of the legs 104 are rotated away from the base 102.

The light body 106 is capable of rotating between multiple positions relative to the base 102. The light body 106 is rotatably connected to a top end of the base 102 by a rotation mechanism for rotation about a rotation axis between the stowed configuration and the open configuration. As discussed previously, the light body 106 includes the mast 108 and the light head 110. In the illustrated embodiment, the mast 108 is a telescoping mast including a plurality of telescoping members 200 and extends between a first end and a second end. The plurality of telescoping members 200 are translated along a mast axis relative to each other so that the mast 108 can be extended and retracted to create different mast heights.

Turning now to FIG. 3, a block diagram of a controller 300 of the work light 100 is shown, according to some embodiments. The controller 300 communicates with a power source 302, a user interface 304, an LED driver 306, and an indicator 320. The controller 300 may include a processing circuit 310, and an input-output (“I/O”) module 314.

The power source 302 may be a removable power source, such as a battery. However, in other embodiments, the power source may be powered by a utility service (e.g., via an AC input), or a constant power source (e.g., external DC power supply). In one example, the power source 302 may be a rechargeable battery, such as a lithium-ion battery, a lithium-iron phosphate battery, etc. In some examples, the rechargeable battery might be a rechargeable power tool battery. The power source 302 shown in FIG. 3 may be a 12 VDC battery, 18 VDC battery, a 40 VDC battery, and/or other battery voltage as required for a given application. The power source 302 may provide power to the various components of the work light 100, such as the controller 300 and the LED driver 306.

The controller 300 includes the processing circuit 310. The processing circuit 310 may include one or more electronic processors 316 as well as a memory device 318. The electronic processors 316 may be communicably connected to one or more of the user interface 304, the LED driver 306, the indicator 320, etc. The electronic processors 316 may be implemented as a programmable microprocessor, an application specific integrated circuit (“ASIC”), one or more field programmable gate arrays (“FPGA”), a group of processing components, or with other suitable electronic processing components.

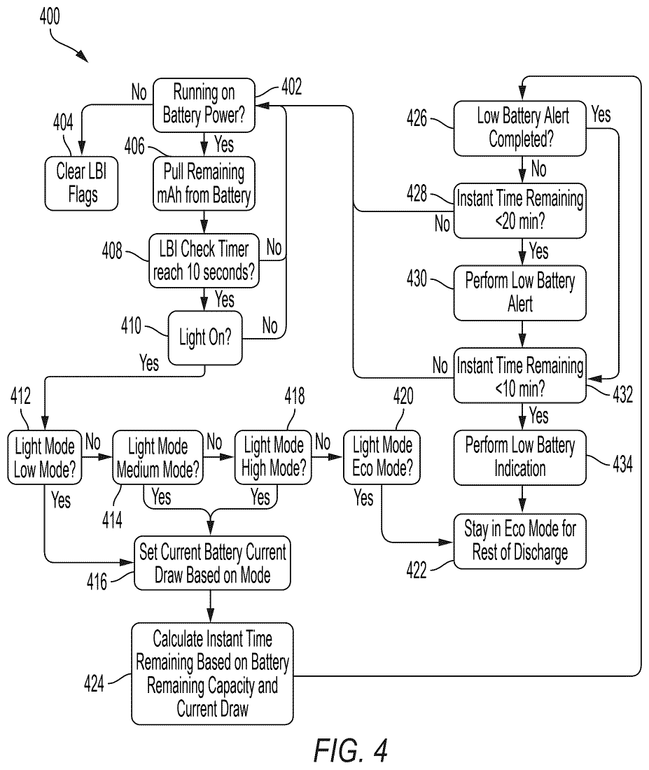

The memory device 318 (for example, a non-transitory, computer-readable medium) includes one or more devices (for example, RAM, ROM, flash memory, hard disk storage, etc.) for storing data and/or computer code for completing or facilitating the various processes, layers, and modules described herein. The memory device 318 may include database components, object code components, script components, or other types of code and information for supporting the various activities and information structure described in the present application. According to one example, the memory device 318 is communicably connected to the electronic processor 316 via the processing circuit 310 and may include computer code for executing (for example, by the processing circuit 310 and/or the electronic processor 316) one or more processes described herein. For example, the memory device 318 may store computer code for executing a low battery indication process (FIG. 4). The I/O module 314 may be configured to interface directly with one or more devices, such as a power supply, a power monitor, etc. In one embodiment, the I/O module 314 may utilize general purpose I/O (GPIO) ports, analog inputs, digital inputs, etc.

The user interface 304 may be similar to the user interface 112 described above, and may include various controls described above, including a brightness control. The brightness control may provide a signal to the controller 300 via the I/O module 314. The controller 300, such as via the processing circuit 310, may be configured to determine a charge level of the power source 302 and control the LED circuit 308 and the indicator 320 based on the charge level. The controller 300 may also control a brightness of the LED circuit 308 (e.g., a lumen level) based on the charge level of the power source 302. For example, a brightness of the LED circuit 308 may decrease as the charge level of the power source 302 decreases. The controller 300 may be configured to receive a signal from the user interface 304 indicating a desired brightness of the LED circuit 308. In one embodiment, the LED circuit 308 may include one or more LEDs and may be provided on the light head 110.

The controller 300 may control the indicator 320 to provide an indication when the charge level of the power source 302 is below a threshold value. In one embodiment, the indicator 320 may include one or more LEDs and may be provided on the user interface 304, near the power source 302 or elsewhere on the base 102 of the work light 100. The indicator 320 may be an LED array provided amongst the LED circuit 308 such that any indication provided by the indicator 320 changes the brightness of the LED circuit 308. For example, the LED array may flash for a period of time (e.g., 2-10 seconds) to provide a low battery indication, which alters the brightness of the LED circuit for the period of time and visually notifies a user in a hard-to-miss way. Instead of flashing during the period of time, the LED array may change colors. When the user interface 304 is a display (e.g., an LCD display), the indicator 320 may be a notification that appears on the display. For example, the indicator may be a colored (e.g., yellow, orange, or red) box that appears on the display with or without a warning message (e.g., “Low Battery,” “Safety Mode,” “Standby Mode,” and/or an image of a turtle, light bulb, or other icon).

The controller 300 may provide an output to the LED driver 306 indicative of a desired brightness of the LED circuit 308. In one embodiment, the LED driver 306 may be configured to control the brightness of the LED circuit 308 using an analog signal. In other examples, a PWM control system may be used to control the brightness of the LED circuit 308.

In one embodiment, the LED driver 306 is an MP24830 from MPS®. However, other LED driver circuits/devices are also contemplated as required for given application. In one embodiment, the controller 300 may provide an input to the LED driver 306 to control whether the dimming of the LED circuit 308 is to be analog dimming or PWM dimming. For example, the controller 300 may provide a signal to pin 5 of the LED driver 306 to control the dimming mode. The LED driver 306 is then configured to generate an output to the LED circuit 308 to control the output of the LEDs of the LED circuit 308. The LED circuit 308 may be dimmed by the LED driver 306 based on a charge level of the power source 302. In one embodiment, the LED circuit 308 may be controlled by the LED driver 306 based on a nominal operating voltage of the power source 302. For example, when a battery with a first nominal operating voltage is coupled to the work light 100, the brightness of the LED circuit 308 may be at a first level and when a battery with a second nominal operating voltage is coupled to the work light 100, the brightness of the LED circuit 308 may be at a second level.

FIG. 4 is a flowchart of a method 400 for controlling an indicator of the work light 100. Although the illustrated method 400 includes specific steps, not all of the steps need to be performed or need to be performed in the order presented. The method 400 may be executed by the work light 100 (e.g., the controller 300 of the work light 100).

The method 400 includes determining whether the work light 100 is running on battery power (at decision step 402). The controller 300 may determine whether the work light is receiving a DC input or an AC input. When the controller 300 determines that the work light 100 is not running on battery power (NO at decision step 402), the method 400 continues to step 404. When the controller 300 determines that the work light 100 is running on battery power (YES at decision step 402), the method continues to step 404.

At step 404, the controller 300 clears the low battery indication (LBI) flags. The LBI flags may be set in the processing circuit 310. At step 406, the controller 300 pulls the remaining current from the battery. For example, the controller may pull the remaining milli-ampere-hours (mAh) from the power source 302 to determine a charge capacity of the power source 302. At decision step 408, the controller 300 determines whether a LBI timer has reached a first threshold time. For example, the controller 300 determines whether the LBI timer has reached 10 seconds. The LBI timer may be provided in the processing circuit 310, and in particular the processor 316. When the controller 300 determines that the first threshold time has not been reached (NO at decision step 408), the method 400 goes back to decision step 402. When the controller 300 determines that the first threshold time has been reached (YES at decision step 408), the method continues to decision step 410.

At decision step 410, the controller 300 determines whether the LED circuit 308 of the work light 100 is ON. For example, the controller 300 determines whether current is flowing to the LED circuit 308 via the LED driver 306. When the LED circuit 308 is not ON (NO at decision step 410), the method 400 goes back to decision step 402. When the LED circuit 308 is ON (YES at decision step 410), the method proceeds to decision step 412.

At decision step 412, the controller 300 determines whether a light mode of the LED circuit 308 is a low mode. For example, the LED driver 306 may drive the LED circuit 308 in a low mode, a medium mode, a high mode, and an eco mode. The low mode may be less than the medium mode and the high mode. The medium mode may be less than the high mode. The eco mode may be less than the low mode, the medium mode, and the high mode. For example, the low mode may be about 50% of the high mode, the medium mode may be about 75% of the high mode, and the eco mode may be about 25% of the high mode. In other embodiments, the modes may have other relative intensities. The various modes may also be referred to as a first mode, a second mode, a third mode, a fourth mode, and the like. The controller 300 may determine the light mode of the LED circuit 308 based on a current draw of the LED driver 306. When the LED circuit 308 is not in a low mode (NO at decision step 412), the method 400 proceeds to decision step 414. When the LED circuit 308 is in a low mode (YES at decision step 412), the method proceeds to step 416.

At decision step 414, the controller 300 determines whether the light mode of the LED circuit 308 is a medium mode. When the LED circuit 308 is not in a medium mode (NO at decision step 414), the method 400 proceeds to decision step 418. When the LED circuit 308 is in a medium mode (YES at decision step 414), the method proceeds to step 416.

At decision step 418, the controller 300 determines whether the light mode of the LED circuit 308 is a high mode. When the LED circuit 308 is not a high mode (NO at decision step 418), the method 400 proceeds to step 420. When the LED circuit 308 is in a high mode (YES at decision step 418), the method proceeds to step 416.

At step 420, the controller 300 determines that the light mode of the LED circuit 308 is in an eco mode. At step 422, the controller 300 controls the LED circuit 308 to stay in eco mode during a total discharge time of the power source 302. For example, during eco mode, the LED driver 306 controls the LED circuit 308 to stay at a first lumen level that does not decrease as the charge capacity of the power source 302 goes down.

At step 416, the controller 300 sets a battery current draw from the power source 302 based on a mode. For example, the controller 300 may set the battery current draw at a first value for the low mode, a second value (greater than the first value) for the medium mode, and a third value (greater than the second value) for the high mode. At step 424, the controller 300 calculates an instant time remaining based on an instant charge capacity and the current battery current draw of the power source 302. The method 400 proceeds to decision step 426.

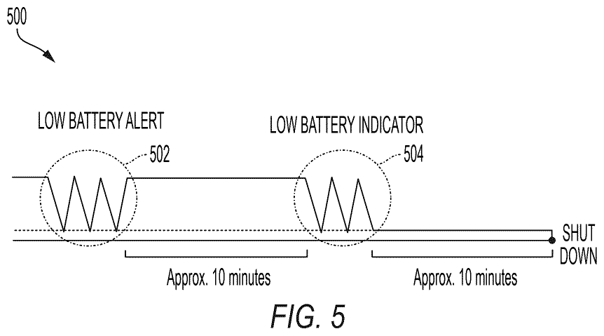

At decision step 426, the controller 300 determines whether a low battery alert is complete. For example, the controller 300 may determine whether the indicator 320 and/or the LED circuit 308 is providing a first indication. FIG. 5 is an eco mode timing diagram 500 including the first indication (e.g., low battery alert 502). The eco mode timing diagram 500 further includes a low battery indicator 504 (e.g., a low battery indication) provided a first amount of time (e.g., 5-15 minutes) after the low battery alert 502. During the first amount of time after the low battery alert 502, the LED circuit 308 stays at the determined light mode (e.g., the LED driver 306 maintains the LED circuit 308 at a lumen level corresponding to one of the low mode, the medium mode, and high mode). After the low battery indicator 504, the LED circuit 308 is dropped to the eco mode (e.g., the LED driver 306 controls the LED circuit 308 to stay at the first lumen level). The LED circuit 308 may remain in the eco mode for a second amount of time (e.g., 5-15 minutes). After the second amount of time, the LED driver 306 controls the LED circuit 308 to turn OFF.

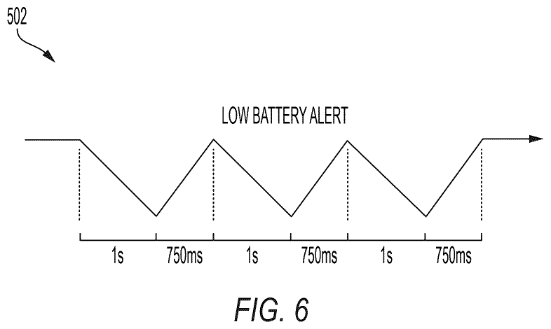

With reference to FIG. 6, the low battery alert 502 (e.g., the low battery alert of decision step 426) may be a series of pulses of the LED circuit 308 or of an LED array provided amongst the LED circuit 308. For example, there may be a total of three pulses where a lumen level output by the LED circuit 308 drops from an original lumen level corresponding to one of the low mode, the medium mode, and high mode to the first lumen level corresponding to the eco mode. The pulse may be a sawtooth pulse (shown in FIG. 6) where the lumen level linearly drops over the course of one second to the first lumen level and then immediately increase back to the original lumen level over the course of 750 milliseconds (ms). The total amount of time for the pulses may be 5.25 seconds. Alternatively, or additionally, the low battery alert 502 may be a series of pulses of the indicator 320 performed substantially the same as the sawtooth pulse shown in FIG. 6.

Returning to FIG. 4, when the controller 300 determines that the low battery alert is not complete (NO at decision step 426), the method 400 proceeds to decision step 428. When the controller 300 determines that the low battery alert is complete (YES at decision step 426), the method 400 proceeds to decision step 432.

At decision step 428, the controller 300 determines whether the instant time remaining of the power source 302 is less than a first predetermined amount of time (e.g., 20 minutes). When the instant time remaining is not less than the first predetermined amount of time (e.g., the instant time remaining is greater than 20 minutes) (NO at decision step 428), the method 400 returns to decision step 402. When the instant time remaining is less than the predetermined amount of time (YES at decision step 428), the method 400 proceeds to step 430.

At step 430, the controller 300 performs the low battery alert. For example, the controller 300 may determine whether the indicator 320 and/or the LED circuit 308 is providing a second indication. The second indication may be the same as the first indication. For example, the second indication may be the low battery alert 502.

Returning to FIG. 4, at decision step 432, the controller 300 determines whether the instant time remaining is less than a second predetermined amount of time (e.g., 10 minutes). The second predetermined amount of time is less than the first predetermined amount of time. When the instant time remaining is not less than the second predetermined amount of time (e.g., the instant time remaining is greater than 10 minutes) (NO at decision step 432), the method 400 returns to decision step 402. When the instant time remaining is less than the second predetermined amount of time (YES at decision step 432), the method 400 proceeds to step 434. In some embodiments, the threshold for time remaining at steps 428, 432 may be different amounts of time (e.g., 10 minutes and 5 minutes, 5 minutes and 1 minute, etc.), depending on the battery or desired operation of the area light 100.

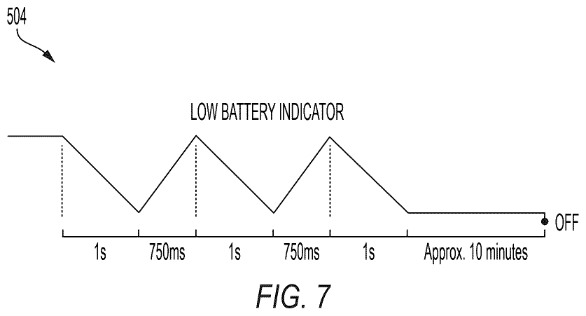

At step 434, the controller 300 performs a low battery indication. For example, the controller 300 may determine whether the indicator 320 and/or the LED circuit 308 is providing a third indication. The third indication may be the same as the first and/or second indication or may be different from the first and/or second indication. With reference to FIG. 7, the low battery indicator 504 (e.g., the third indication of step 434) may be a series of pulses of the LED circuit 308 or of an LED array provided amongst the LED circuit 308. For example, there may be a total of three pulses where a lumen level output by the LED circuit 308 drops from an original lumen level corresponding to one of the low mode, the medium mode, and high mode to the first lumen level corresponding to the eco mode. The pulse may be a sawtooth pulse (shown in FIG. 7) where the lumen level linearly drops over the course of one second to the first lumen level and then immediately increase back to the original lumen level over the course of 750 ms. The total amount of time for the pulses may be 4.5 seconds. At the end of the last pulse (e.g., after 4.5 seconds), the lumen level decreases to the first lumen level corresponding to the eco mode. The controller 300 may maintain the lumen level at the first lumen level corresponding to the eco mode for a predetermined amount of time (e.g., the second amount of time) until the power source 302 is fully depleted or the work light 10 is shut down. Alternatively, or additionally, the low battery indicator 504 may be a series of pulses of the indicator 320 performed substantially the same as the sawtooth pulse shown in FIG. 7. The method 400 then proceeds to step 422 to switch to and operate in eco mode for the remainder of the state of charge.

Accordingly, the invention provides an area light that provides an indication based on a remaining runtime of a power source coupled to the area light.

The embodiment described above and illustrated in the figures are presented by way of example only and are not intended as a limitation upon the concepts and principles of the present invention. As such, it will be appreciated that various changes in the elements and their configuration and arrangement are possible without departing from the spirit and scope of the present invention. Various features and advantages of the invention are set forth in the following claims.

What is claimed is:

1. An area light, comprising:
a base including a battery receptacle for receiving a battery;
a LED circuit;
an indicator; and
a controller coupled to the battery receptacle, the LED circuit, and the indicator and configured to:
control the LED circuit to output a first lumen level,
control the indicator to output a first indication when an instant time remaining of the battery is less than a first predetermined amount of time,
control, after the first indication, the LED circuit to output the first lumen level,
control the indicator to output a second indication when the instant time remaining of the battery is less than a second predetermined amount of time, the second predetermined amount of time being less than the first predetermined amount of time, and
control, after the second indication, the LED circuit to output a second lumen level that is less than the first lumen level.

2. The area light of claim 1, wherein the first indication is a first series of pulses of the indicator.

3. The area light of claim 2, wherein the first series of pulses includes three pulses.

4. The area light of claim 2, wherein the first series of pulses lasts for 5.25 seconds.

5. The area light of claim 1, wherein the indicator is part of the LED circuit.

6. The area light of claim 5, wherein during the first indication, a lumen level of the LED circuit drops from the first lumen level to another lumen level.

7. The area light of claim 6, wherein the lumen level linearly drops from the first lumen level to the another lumen level over a first period of time, and
wherein the lumen level linearly rises from the another lumen level to the first lumen level over a second period of time, different from the first period of time.

8. The area light of claim 1, wherein the second indication is a second series of pulses of the indicator.

9. The area light of claim 8, wherein the second series of pulses includes two and a half pulses.

10. The area light of claim 8, wherein the second series of pulses lasts for 4.5 seconds.

11. The area light of claim 1, wherein the indicator is separate from the LED circuit and located on the base.

12. A method of controlling an area light, the area light including a base having a battery receptacle for receiving a battery, a LED circuit, an indicator, and a controller, the method comprising:
controlling, with the controller of the area light, the LED circuit to output a first lumen level;
controlling, with the controller of the area light, the indicator to output a first indication when an instant time remaining of the battery is less than a first predetermined amount of time;
controlling, with the controller of the area light and after the first indication, the LED circuit to output the first lumen level;
controlling, with the controller of the area light, the indicator to output a second indication when the instant time remaining of the battery is less than a second predetermined amount of time, the second predetermined amount of time being less than the first predetermined amount of time; and
controlling, with the controller of the area light and after the second indication, the LED circuit to output a second lumen level that is less than the first lumen level.

13. The method of claim 12, wherein controlling the indicator to output the first indication includes controlling the indicator to output a first series of pulses.

14. The method of claim 12, wherein controlling the indicator to output the second indication includes controlling the indicator to output a second series of pulses.

15. The method of claim 12, wherein the controller controls the LED circuit to output the first lumen level for a second amount of time, and wherein the method further comprises controlling, with the controller of the area light, the LED circuit to turn off after the second amount of time.

16. The method of claim 12, wherein the indicator is part of the LED circuit, wherein controlling the indicator to output the first indication includes controlling the LED circuit to drop from the first lumen level to another lumen level, and wherein controlling the indicator to output the second indication includes controlling the LED circuit to drop from the first lumen level to the another lumen level.

17. An area light, comprising:
a base including a battery receptacle for receiving a battery;
a LED circuit; and
a controller coupled to the battery receptacle and the LED circuit, wherein the controller is configured to:
control the LED circuit to output a first lumen level,
control the LED circuit to output a first indication when an instant time remaining of the battery is less than a first predetermined amount of time,
control, after the first indication, the LED circuit to output the first lumen level,
control the LED circuit to output a second indication when the instant time remaining of the battery is less than a second predetermined amount of time, the second predetermined amount of time being less than the first predetermined amount of time, and
control, after the second indication, the LED circuit to output a second lumen level that is less than the first lumen level.

18. The area light of claim 17, wherein the first indication is a first series of pulses of an LED array of the LED circuit.

19. The area light of claim 17, wherein the second indication is a second series of pulses of an LED array of the LED circuit.

20. The area light of claim 17, wherein the controller controls the LED circuit to output the first lumen level by setting a battery current draw from the battery to a first value corresponding to the first lumen level.
